(19) United States
(12) Patent Application Publication
(10) Pub. No.: US 2022/0303642 A1
(43) Pub. Date: Sep. 22, 2022

(54) SECURING VIDEO DISTRIBUTION

(71) Applicant: Product Development Associates, Inc., Burnsville, MN (US)

(72) Inventor: Bradley Vernon Briercliffe, Burnsville, MN (US)

(21) Appl. No.: 17/206,724

(22) Filed: Mar. 19, 2021

(51) Int. Cl. H04N 21/8358; H04L 9/08; H04L 9/32; G06F 21/16

(52) U.S. Cl. CPC H04N 21/8358; H04L 9/0825; H04L 9/3247; G06F 21/16

(57) ABSTRACT

An encoder apparatus includes an input/output (I/O) subsystem and processing circuitry. The I/O subsystem can receive video data. The processing circuitry can be coupled to the encoder input. The processing circuitry can be configured to gather a packet from the video data and generate a first watermark for signing the packet. The processing circuitry can still further be configured to encode an Ethernet frame comprising at least the signed packet.

The present disclosure pertains to systems and methods for providing security for real-time video using Ethernet frames that include video segments.

Sharing live, or real-time, video content for remote monitoring can be subject to security risks. Such security risks can include the risk of a malicious actor modifying the video content. Protection of content therefore has become an important consideration for video applications.

### SUMMARY

An exemplary encoder apparatus can include an input/output (I/O) subsystem to receive video data comprising a plurality of packets. The packets can comprise at least a portion of a video line. The packet can comprise a horizontal video line.

In an example embodiment, the apparatus can further include processing circuitry coupled to the I/O system and configured to gather a packet from the plurality of packets of the video data, generate a first watermark for signing the packet, generate the signed packet based on the first watermark, and encode an Ethernet frame comprising at least the signed packet. The Ethernet frame can comprise a segment number that indicates a position of the packet in the plurality of packets. The Ethernet frame can comprise a cyclic redundancy check (CRC) field indicating that the CRC field should be ignored. The CRC field can be comprised of zeroes.

In an example embodiment, the processing circuitry can further transmit a public key for decoding the signed packet. The processing circuitry can further generate the first watermark based on the public key. The processing circuitry can gather a subsequent packet from the video data and calculate a second watermark, based on the first watermark, for signing the subsequent packet. The second watermark can comprise a second watermark portion concatenated to the first watermark. The processing circuitry can further gather a number of subsequent packets subsequent to the subsequent packet and calculate a number of additional watermarks, sequentially, with each of the additional watermarks being a concatenation comprising a new portion and the previous watermarks.

An exemplary decoder apparatus can include a decoder input to receive a plurality of Ethernet frames. The exemplary decoder apparatus can further include processing circuitry operably coupled to the decoder input. The processing circuitry can receive the plurality of Ethernet frames, each Ethernet frame of the plurality of Ethernet frames comprising a watermark and a plurality of packets of video content. The processing circuitry can reconstruct the video content based on the watermark and on the plurality of packets. The processing circuitry can receive a public key corresponding to at least one Ethernet frame of the plurality of Ethernet frames. The processing circuitry can reconstruct the video content based also on a public key. The processing circuitry can gather individual packets from an Ethernet frame of the plurality of Ethernet frames. The processing circuitry can detect whether the individual packets includes a watermark. If a packet of the individual packets does not include the watermark, the processing circuitry can provide the packet to the display device, and compare the watermark to an expected watermark otherwise. The processing circuitry can ignore a cyclic redundancy check (CRC) field within at least one Ethernet frame of the plurality of Ethernet frames.

In an example embodiment, the processing circuitry can provide the reconstructed video content to a display device. Providing the reconstructed video can include determining whether the watermark matches an expected watermark and providing video content corresponding to the watermark if the watermark matches an expected watermark, and set an alteration flag otherwise.

An exemplary system can comprise a network interface configured to receive a plurality of packets comprising digital video and audio content. The system can include an encoder apparatus coupled to the network interface and configured to gather a packet from the plurality of packets. The encoder apparatus can generate a first watermark for signing the packet. The encoder apparatus can generate a signed packet based on the watermark. The encoder apparatus can provide an Ethernet frame for transmission, the Ethernet frame comprising at least the signed packet. The system can further include a decoder apparatus, coupled to the encoder apparatus and configured to reconstruct the packet based on the watermark.

### BRIEF DESCRIPTION OF THE DRAWINGS

Throughout the specification, reference is made to the appended drawings, where like reference numerals designate like elements, and wherein:

FIG. 1 is a block diagram of a system in which example embodiments can be implemented.

FIG. 2 is a block diagram of an encoder apparatus according to example embodiments.

FIG. 3 is a flowchart illustrating a method for generating a verifiable digital video and audio stream according to example embodiments.

FIG. 4 is a block diagram of packet generation at different layers according to example embodiments.

FIG. 5 illustrates an Ethernet frame in further detail according to example embodiments.

FIG. 6 is a block diagram of a decoder apparatus according to example embodiments.

FIG. 7 is a flowchart illustrating a method for generating a verified digital video and audio stream according to example embodiments.

FIG. 8 is a block diagram of an example of components that can be present in an encoder or decoder according to example embodiments.

### DETAILED DESCRIPTION

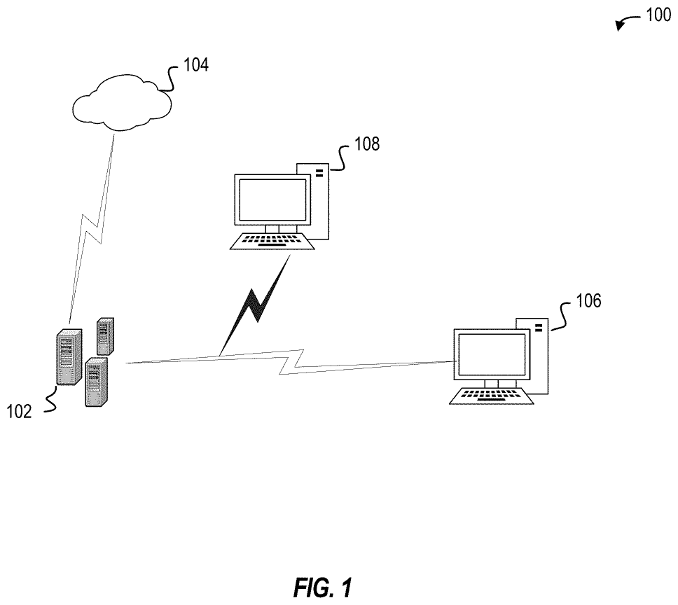

Exemplary methods, apparatus, and systems shall be described with reference to FIGS. 1-8. It will be apparent to one skilled in the art that elements or processes from one embodiment can be used in combination with elements or processes of the other embodiments, and that the possible embodiments of such methods, apparatus, and systems using combinations of features set forth herein is not limited to the specific embodiments shown in the Figures and/or described herein. Further, it will be recognized that the embodiments described herein can include many elements that are not necessarily shown to scale. Still further, it will be recognized that timing of the processes and the size and shape of various elements herein can be modified but still fall within the scope of the present disclosure, although certain timings, one or more shapes and/or sizes, or types of elements, can be advantageous over others.

FIG. 1 is a block diagram of a system 100 in which example embodiments can be implemented. Servers 102 can receive content, for example video content and/or audio content, from remote storage (e.g., the cloud 104) for streaming to a user system 106. While one user system 106 is shown, streaming can occur to several user systems, and can also include live stream sources. Security issues can occur during transmission from the servers 102 to the user system 106, including eavesdropping or spoofing by an unauthorized user system 108. For example, the apparatus can verify the content and detect unauthorized changes that occur during deep-fake manipulations of video and/or audio. The detection apparatus can successfully identify these manipulations in both live and previously-recorded streams.

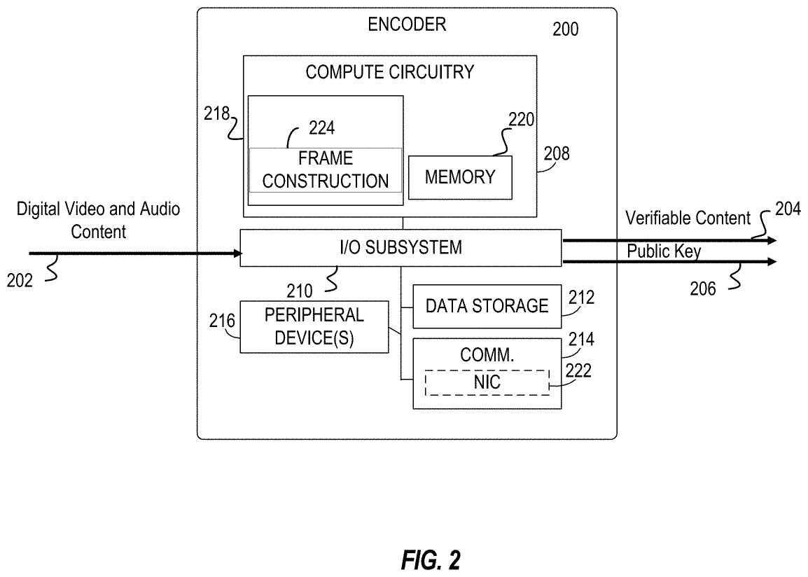

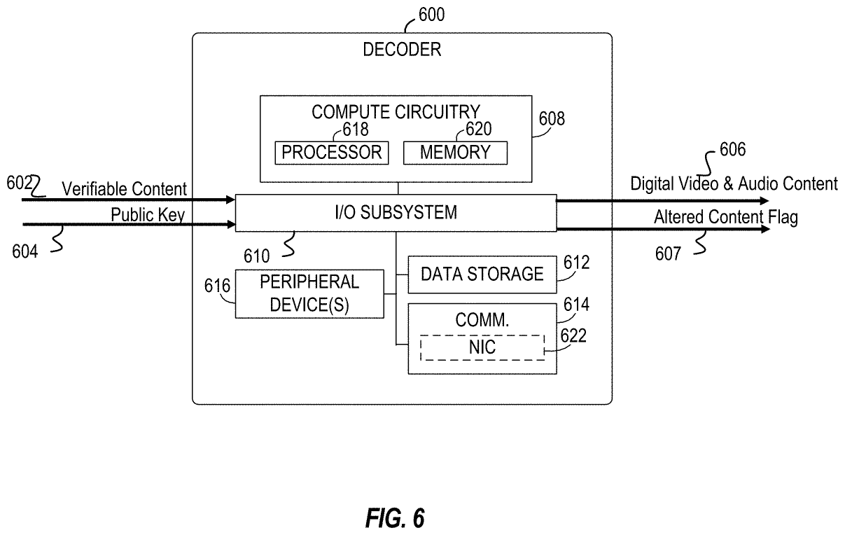

To prevent these security issues and other problems, methods, apparatuses, and systems according to various embodiments described herein provide encoder and decoder functionality for protecting video and other content. FIG. 2 is a block diagram of an encoder apparatus 200 according to example embodiments. The encoder apparatus 200 can be provided as a component of one or more of server/s 102 to generate verifiable content and provide that verifiable content to user system/s 106. The verifiable content can include Ethernet frames having watermarks, and additionally packets within the Ethernet frames can include signatures that can be verified using the Ethernet watermarks. User system/s 106 can include a decoder apparatus 600 (FIG. 6) to decode verifiable content for display on a display device, for example.

### Encoder Apparatus

### Encoder Compute Circuitry

The encoder apparatus 200 may include a compute engine (also referred to herein as “compute circuitry”) 208, an input/output (I/O) subsystem 210, data storage device 212, communication circuitry 214, and, optionally, one or more peripheral devices 216. In other examples, respective compute devices can include other or additional components, such as those typically found in a computer (e.g., a display, peripheral devices, etc.). Additionally, in some examples, one or more of the illustrative components can be incorporated in, or otherwise form a portion of, another component.

The encoder apparatus 200 can be embodied as any type of engine, device, or collection of devices capable of performing various compute functions. In some examples, the encoder apparatus 200 can be embodied as a single device such as an integrated circuit, an embedded system, a field-programmable gate array (FPGA), a system-on-a-chip (SOC), or other integrated system or device. In the illustrative example, the encoder apparatus 200 includes or is embodied as a processing circuitry 218 and a memory 220.

The processing circuitry 218 can be embodied as any type of processor capable of performing the functions described herein (e.g., providing watermarks or other protection for video data). For example, the processing circuitry 218 can be embodied as a multi-core processor(s), a microcontroller, or other processor or processing/controlling circuit. The processing circuitry 218 can include any suitable hardware or devices to read video data, calculate watermarks for data security, and generate Ethernet frames, etc. The processing circuitry 218 can include, e.g., one or more processors, logic gates, clocks, queues and First-In-First-Out (FIFO) for holding intermediate data packages, Electro-Static Discharge (ESD) protection circuitry for input and output signals, line drivers and line receivers for interfacing to external devices, etc. In some examples, the processing circuitry 218 can be embodied as, include, or be coupled to an FPGA, an application specific integrated circuit (ASIC), reconfigurable hardware or hardware circuitry, or other specialized hardware to facilitate performance of the functions described herein.

The encoder apparatus 200 receives as input native video data 202 comprised of a plurality of packets via the I/O subsystem 210, which can be embodied as circuitry and/or components to facilitate input/output operations with compute circuitry 208 (e.g., with the processing circuitry 218 and/or the main memory 220) and other components of the compute circuitry 208. For example, the I/O subsystem 210 can be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 210 can form a portion of a system-on-a-chip (SoC) and be incorporated, along with one or more of the processing circuitry 218, the memory 220, and other components of the compute circuitry 208, into the compute circuitry 208. The I/O subsystem 210 can include any suitable connector or interface for receiving native video data 202 such as, e.g., Video Graphics Array (VGA), RS-343A, High-Definition Multimedia Interface (HDMI), Digital Visual Interface (DVI), DisplayPort (DP), carried as DisplayPort protocol over USB 3.0, 3.1, National Television Standard Committee (NTSC)-RS170, etc. The I/O subsystem 210 can be operably coupled to and receive native video data from any suitable source such as, e.g., a computer, a video camera, a live video feed, sensor video products, etc. The I/O subsystem 210 can receive non-video or out-of-band data such as, e.g., input and/or sound data.

The I/O subsystem 210 can be operably coupled to the processing circuitry 218 to provide the received native video data and/or out-of-band data to the processing circuitry 218. The disclosure herein will use the terms “native video data,” “video segment,” and “video line.” As used herein, it is to be understood that native video data can include video frames including pixel data, horizontal synchronization tags, and vertical synchronization tags. Native video data can be synchronized by a free running clock source that generates a consistent time base for the transmission of data. The atomic unit of video data can be a pixel. A pixel can be assigned a unique color value. Pixels can be transmitted on each “tick,” or discrete event, of the clock source. A set of pixels can be generated left to right forming a complete horizontal video line. Horizontal video lines can be sent one after another, top-to-bottom to form a complete video frame. By sending many video frames each second, an observer can interpret these many static video frames, or pictures, as smooth motion video.

### Native Video Data

As described herein, native video data formats can have a clock source, a set of pixels, and a set of horizontal video lines. Differences in the native video data formats can include the speed of the clock, how many bits define the color of a pixel, how many pixels form a horizontal video line, and how many horizontal video lines “make up” a complete video frame. The illustrative apparatuses, systems, and methods described herein can accommodate an arbitrary pixel size, any number of pixels per line, and any number of lines per frame; therefore, the illustrative apparatuses, systems, and methods described herein can be described as being capable of handling any native video data format.

Besides pixels, native video data can include horizontal and vertical synchronization tags that mark the end of horizontal video lines and the end of complete video frames. Native video data can be sent over a deterministic, reliable link and it can be assumed that all data transmitted will be received in order and in time. With native video data, there can be no method to decode an arbitrary component within the video. For example, a receiver of native video data can wait for a vertical synchronization tag to occur to determine, or know, when a new frame of video has started. Once the vertical tag has been detected, the receiver can maintain a lock on the original clock source so the receiver can correctly interpret the video data.

A video line can include as lossless data representative of a horizontally or vertically contiguous line of pixels of a video frame of native video data. A video segment can include lossless data representative of a subset of a single native video frame of native video data arranged in a manner such that the native video can be reconstructed from such video segments. Each video segment can be associated with a segment number. Each segment number can indicate a predetermined location within a frame of native video data for each pixel of the video segment based on the order of the pixels in the video segment. For example, video segments can include a video line. In another example, the video segment can include a series of pixels that are spaced apart every 1920th pixel of the video frame. The segment number can indicate the position of the first pixel of the video segment, and each pixel thereafter is spaced 1920 pixels away from the pixel preceding it. In a still further example, the video segment can represent a rectangular section of pixels of the native video data and the segment number indicates the position of the rectangular segment in the native video frame.

### Method for Generating Verifiable Content

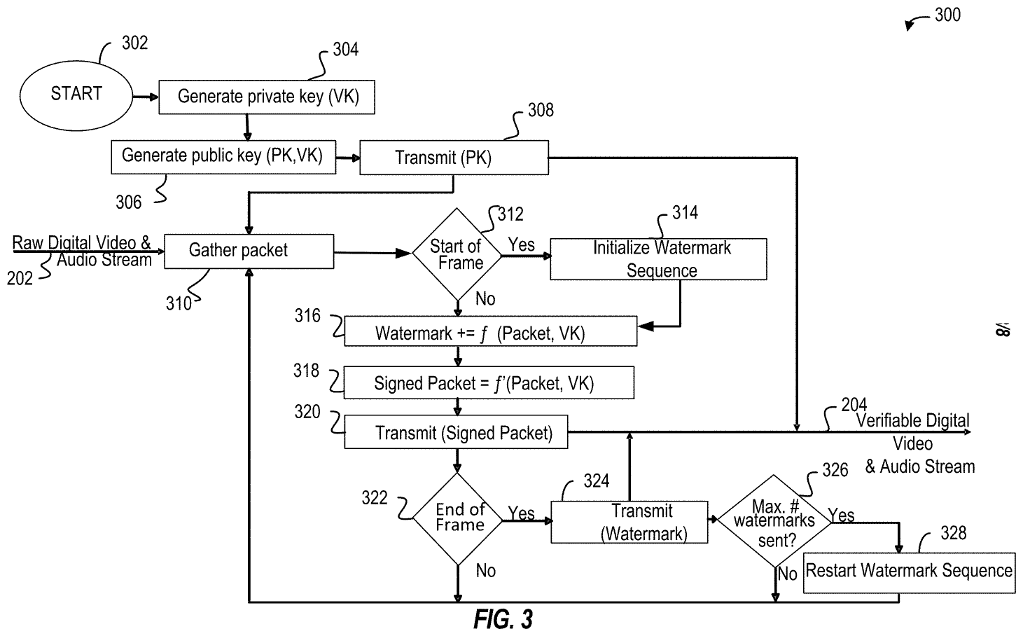

Once native video data has been received, the processing circuitry 218 can generate watermarks and provide Ethernet frames including watermarks, verifiable content 204, and public key/s 206 as output via the I/O subsystem 210. Watermarks can be associated with the verifiable content 204 and a watermark can comprise a sequence of digits. In example embodiments, a watermark can be between 100-200 bytes long, although embodiments are not limited thereto. In example embodiments, a watermark can be 128 bytes (1024 bits) long, although embodiments are not limited thereto. The processing circuitry 218 can perform any of the operations of the method 300 illustrated in FIG. 3 to calculate watermarks and encode Ethernet frames comprised of verifiable content 204 and public key/s 206.

Referring to FIG. 3, the method 300 can begin 302 with the processing circuitry 218 generating at least one private key at operation 304. In some examples, user system/s 106 are provided with private keys when subscribing to a service or setting up another trusted user scenario with implementers of video streaming services. Based on the private key generated or provided in operation 304, the processing circuitry 218 can generate a public key in operation 306 and provide this public key in operation 308 for use in subsequent operations of method 300. The public key generated in operation 306 can further be provided along with the verifiable digital video and audio stream that is generated in the subsequent operations of method 300. The processing circuitry 218 can perform operations 304 and 306 using any standard key generation algorithm, including, for example, Rivest-Shamir-Adleman (RSA) algorithms, Advanced Encryption Standard (AES) algorithms, Diffie-Hellman algorithms, etc.

In operation 310, the processing circuitry 218 can gather a packet from the plurality of packets of the raw digital video and audio stream (e.g., “video data”). In some example embodiments, the processing circuitry 218 can first check, in operation 312, whether the most recently gathered packet signifies the start of a video frame.

In operation 314, if the most recently gathered packet is the start of a video frame, then the watermark sequence is initialized (or re-initialized, in the case of subsequent video frames). The processing circuitry 218 generates an initial watermark for the video frame in operation 316 based on the packet, private key VK, etc. Otherwise, operation 316 proceeds based on previous watermarks, in addition to the packet, private key, or other data. For example, previous watermarks can be concatenated or used for seeding a subsequent watermark in operation 316.

In operation 318, the processing circuitry 218 signs the most recently-gathered packet, which includes modifying that packet using the watermark (which was generated using the private key), thereby transforming the packet into a signed packet. The signature process of operation 318 can be similar to parity encoding, in which raw data is forced to always sum to an even value, but instead of being forced to always sum to an even value, the signature ensures that a decoder checking process (described later herein) will always match the watermark. Subsequent to operation 318, the packet will include at least one field of modified data (e.g., a signature). The modified data can be encoded as metadata appended (at the end or beginning or predefined location) to the raw pixel data for the packet, to form a modified data set. By adding the signature as metadata, a non-watermarking decoder can still access content, but will not be able to verify that the content has not been spoofed or otherwise modified. A decoder apparatus 600 according to embodiments can use the signature to verify the packet content.

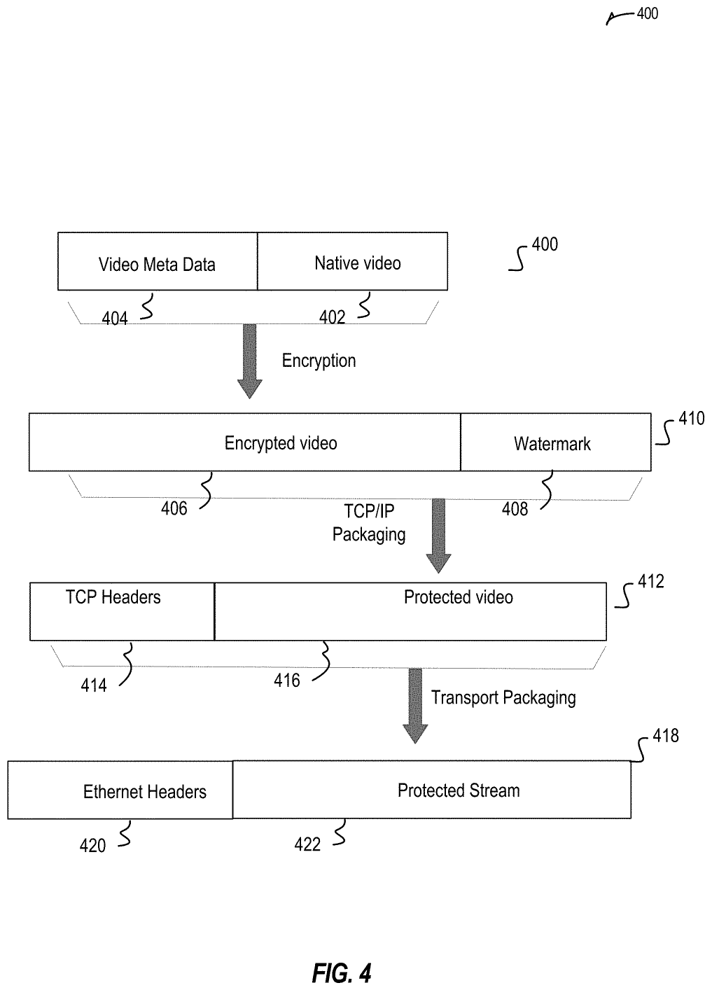

In operation 320, the processing circuitry 218 forwards the signed packet to upper layer circuitry. For example, the processing circuitry 218 can prepare the signed packet and transmit by wired or wireless means to user system/s 106 (FIG. 1). In example embodiments, the processing circuitry 218 will transmit, pass or provide the signed packet to a next higher layer for packaging as will be described in more detail with reference to FIG. 4 later herein. For example, the processing circuitry 218 can provide signed packets to a Transmission Control Protocol (TCP) layer for packaging into a TCP/Internet Protocol (IP) packet.

In operation 322, if the processing circuitry 218 determines that the packet was at the end of a video frame, the watermark generated in operation 316 is additionally transmitted along with that packet in operation 324. The watermark transmitted in operation 324, therefore, can validate signatures describing multiple packets of data (e.g., all of the packets in a video frame), and the watermark can comprise a sequence of digits, for example, at least x digits. The receiving user system/s 106 can detect whether individual packet/s or video frames of packets have been changed for example through spoofing or other means, through comparison and/or analysis of the watermarks received as will be described in more detail below.

If the processing circuitry 218 determined in operation 322 that the end of a video frame was not reached, then further packets are gathered when operations are resumed at operation 310. The processing circuitry determines whether the maximum number of watermarks has been transmitted in operation 326. The maximum number of watermarks can be adjustable. In example embodiments, the maximum number can be defined based on the user environment. In example embodiments, the maximum number can be triggered by a number of different watermarks transmitted in a given unit of time. In example embodiments the maximum number of watermarks can be minimized to minimize computational overhead. Depending on whether the processing circuitry determines in operation 326 that the maximum number of watermarks has been transmitted, the watermark sequence can be reinitialized in operation 328 before resuming operations at operation 310. With this reinitialization, a next subsequent watermark can be generated based on signatures for packets in a previous video frame in operations 306 and 308. For example, the next subsequent watermark can be generated based on a hash of a sum of previous signatures.

Referring again to FIG. 2, the verifiable content 204 can be formatted into Ethernet frames, accumulated using frame construction circuitry 224 of the processing circuitry 218. Frame construction circuitry 224 can perform operations including segment counting and cyclic redundancy check (CRC) suppression circuitry, among other operations, to generate Ethernet frames. Segment counting can provide a segment number based on the position of the video segment position in a video frame of native video data. For example, if the video segment is a horizontal video line, the segment number can indicate which horizontal video line within a video frame the video segment represents. Ethernet frames can be formatted according to U.S. Pat. No. 10,827,147 B1, which is incorporated herein by reference in its entirety.

The frame construction circuitry 224 can generate an Ethernet frame including a video segment and the segment number. In general, native video data streams can be assumed to be deterministic (e.g., transmission time is consistent, based on a clock source, etc.), reliable (all data sent will be received), and lossless (no reduction in data fidelity). However, Ethernet protocols may be neither deterministic nor inherently reliable. It may not be possible to guarantee the delivery order of Ethernet frames; they can arrive out of order. To solve the out-of-order problem each of Ethernet frames (which comprises at least verifiable content 204) can include a segment number that identifies the position of the video segment position in a video frame of native video data. The segment number can ensure the video frame can be reassembled in the correct order. By encoding a video segment within an Ethernet frame, it may be possible to maintain the relative placement of pixels within a video frame. Additionally, such protocols can ensure there is no loss of content, thereby providing a lossless protocol.

The frame construction circuitry 224 can suppress CRCs by, for example, setting a CRC checksum of the generated Ethernet frame to zero. Typically, Ethernet frames can include and be protected by CRCs to address reliability issues. For example, CRCs can ensure any corruption of Ethernet frames will be detected. Any Ethernet frame with any amount of corruption may be discarded. However, in example embodiments CRCs are suppressed and watermarks, generated as described above, are used for protecting video data and ensuring video data has not been corrupted, spoofed, etc.

The encoder apparatus 200 outputs verifiable content 204 and a public key 206 via the I/O subsystem 210. The encoder I/O subsystem 210 can include any suitable connector or interface for transmitting Ethernet frames or other data such as, e.g., an Attachment Unit Interface (AUI), an N connector, a vampire tap, a Bayonet Neill-Councilmen (BNC) connector, Small Form Factor Pluggable (SFP+), Registered Jack (RJ), etc. The I/O subsystem 210 can be operatively coupled to any suitable device, e.g., a network, a computer, a switch, a decoder device, a network bridging device, a range extender, etc. The I/O subsystem 210 can transmit the verifiable content 204 to any of the operatively coupled devices including, for example, user system/s 106 (FIG. 1).

### Packet Representations and Ethernet Frames

FIG. 4 is a block diagram of packet generation at different layers according to example embodiments. As mentioned earlier herein, the packet representations shown in FIG. 4 can be generated during different operations of method 300 or as a result of different operations of method 300. Accordingly, reference is made to operations of method 300 during description of packet representations below.

Packet 400 represents a packet as the processing circuitry 218 gathers the packet at operation 310. Packet 400 can include native video data 402 and video meta data 404. Native video data 402 can be similar to native video data 202 (FIG. 2) as discussed earlier herein. Video meta data 404 can include, for example, text that references the video and that can be used by search engines to show video results or content recommendations, for example the title of the video, keywords, date, timestamps, etc. Video meta data 404 can also include a signature generated using a watermark as discussed earlier herein.

The encoder processing circuitry 218 generates an encrypted video frame 410 using public and private keys generated in operations 304, 306 and 308 to created encrypted video 406 in operation 318. The processing circuitry 218 adds a watermark 408 to the video frame in operations 316 and 318. The watermark 408 can include a string of digits, for example 24 digits or 32 digits, generated according to operation 316.

The processing circuitry 218 can package the encrypted video frame 410 into a TCP/IP packet 412 for transmission using a TCP/IP protocol. The TCP/IP packet 412 can include header information 414 and protected video 416. TCP provides a communication service at an intermediate level between an application program and IP. TCP provides host-to-host connectivity at the transport layer of the Internet model. At the transport layer, TCP handles all handshaking and transmission details and presents an abstraction of the network connection to the application typically through a network socket interface. TCP is used extensively by many internet applications, including the World Wide Web (WWW), email, File Transfer Protocol (FTP), Secure Shell, peer-to-peer file sharing, and streaming media and therefore can be used for transmitting video according to embodiments.

The processing circuitry 218 can encapsulate each protected video 416 segment into an IP packet 412 by adding header information 414 to the protected video 416, wherein the header information 414 includes (among other data) the destination IP address.

As described earlier herein, frame construction circuitry 224 generates Ethernet frames 418, which can include Ethernet headers 420 in addition to protected video stream data 422. The Ethernet headers 420 can include a destination address. The destination address can include any suitable address type such as, e.g., a direct address, a multicast address, or a broadcast address. In at least one embodiment, the Ethernet frame includes a multicast address.

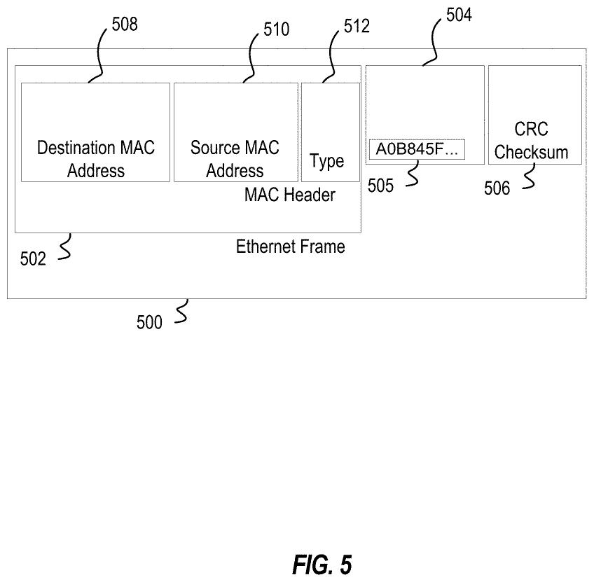

FIG. 5 illustrates an Ethernet frame 500 in further detail according to example embodiments. Ethernet frame 500 can be a protocol data unit of the data link layer of the Open Systems Interconnection (OSI) model. Ethernet frame 500 can include a Media Access Control (MAC) header 502, a payload 504, and a CRC checksum 506. The MAC header 502 can include a destination MAC address 508, a source MAC address 510, and a frame type 512. The destination MAC address 508 can include six bytes of data, each byte represented herein as couplings of hexadecimal digits. In one embodiment, the destination MAC address 508 can indicate a multicast group that the Ethernet frame 500 is to be transmitted to. In another embodiment, the destination MAC address 508 may not be a multicast address and may be a direct MAC address. The source MAC address 510 can include six bytes of data, each byte represented herein as couplings of hexadecimal digits. The source MAC address 510 can indicate the MAC address of the apparatus that generated the Ethernet frame 500. The frame type 512 can indicate what type or kind of Ethernet frame that Ethernet frame 500 is, such as, e.g., standard, jumbo, baby giant, super jumbo, etc. In at least one example, Ethernet frame 500 is a jumbo frame. The Ethernet frame 500 can be any Ethernet frame as defined by the IEEE 802.3 Standard for Ethernet, which is incorporated herein by reference in its entirety.

The size of the payload 504 can be determined by the type of Ethernet frame. The Ethernet frame type and the corresponding payload size can be chosen based on the size of the data to be to be transmitted. The payload 504 can include a watermark 505 as determined above with respect to FIG. 3. In examples, the watermark can include a string of digits. In some example, the watermark can be 100-200 bytes in length, although embodiments are not limited thereto. In some examples, the watermark can be 1024 bits in length. The payload 504 can further include a video segment and a segment number. Accordingly, the size of the Ethernet frame type of Ethernet frame 500 and the corresponding size of payload 504 can be chosen based on the size of the video frame to be transmitted. In at least one example, the Ethernet frame 500 is a jumbo frame and the size of the payload 504 can be up to 9000 bytes.

Ethernet frame 500 may include the CRC checksum 506. CRC checksums may be used to verify the integrity of Ethernet frame 500. However, for real-time transmission of video data, it may be beneficial to ignore cyclic redundancy checks. Further, embodiments include watermarks as described herein for data security and integrity, and accordingly CRC can be suppressed, ignored, or eliminated. In some examples (e.g., real-time video transmission), speed may be more important than data integrity. The CRC checksum 506 can be set to zero to indicate that the cyclic redundancy check is to be suppressed or ignored.

### Decoder Apparatus

As mentioned earlier herein user system/s 106 (FIG. 1) can include a decoder apparatus 600 to decode verifiable content, received from the encoder apparatus 200, to generate native video data for display on a display device, for example. FIG. 6 is a block diagram of a decoder apparatus 600 according to example embodiments.

Similar to the encoder apparatus 200, the decoder apparatus 600 includes a compute engine (also referred to herein as “compute circuitry”) 608, an input/output (I/O) subsystem 610, data storage device 612, a communication circuitry 614, and, optionally, one or more peripheral devices 616. In other examples, respective compute devices can include other or additional components, such as those typically found in a computer (e.g., a display, peripheral devices, etc.). Additionally, in some examples, one or more of the illustrative components can be incorporated in, or otherwise form a portion of, another component. The bandwidth of the decoder apparatus 600 can be slightly larger than the native video data bandwidth requirement. For example, if the native video generates 8 Gigabits of data per second, the decoder apparatus 600 may have slightly more than 8 Gigabit of bandwidth such as, e.g., 10 Gigabits. Ethernet frames may include some amount of overhead in addition to the base data set so this extra bandwidth can accommodate the additional data.

As with the encoder apparatus 200, the decoder apparatus 600 can be embodied as any type of engine, device, or collection of devices capable of performing various compute functions. In the illustrative example, the decoder apparatus 600 includes or is embodied as a processing circuitry 618 and a memory 620. The processing circuitry 618 can be embodied as any type of processor capable of performing the functions described herein (e.g., decoding protected Ethernet frames to provide native video). For example, the processing circuitry 618 can be embodied as a multi-core processor(s), a microcontroller, or other processor or processing/controlling circuit. The processing circuitry 618 can include any suitable hardware or devices to reconstruct video data, compare watermarks for data security when CRCs are absent or disabled, etc. The processing circuitry 618 can include, e.g., one or more processors, logic gates, clocks, queues, and FIFO for holding intermediate data packages, ESD protection circuitry for input and output signals, line drivers and line receivers for interfacing to external devices, etc. In some examples, the processing circuitry 618 can be embodied as, include, or be coupled to an FPGA, an ASIC, reconfigurable hardware or hardware circuitry, or other specialized hardware to facilitate performance of the functions described herein.

The decoder apparatus 600 receives as input verifiable content 602 packaged, for example, in Ethernet frames, in addition to one or more public key/s 604. The verifiable content 602 and public key/s 604 can be the same as the verifiable content 204 and public key/s 206 (FIG. 2). At least the verifiable content 602 and public key/s 604 can be received via the I/O subsystem 610, which can be embodied as circuitry and/or components to facilitate input/output operations with compute circuitry 608 (e.g., with the processing circuitry 618 and/or the main memory 620) and other components of the compute circuitry 608. For example, as with the I/O subsystem 210 (FIG. 2), the I/O subsystem 610 can be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 610 can form a portion of an SoC and be incorporated, along with one or more of the processing circuitry 618, the memory 620, and other components of the compute circuitry 608.

The I/O subsystem 610 can include any suitable connector or interface for receiving Ethernet frames or other data, e.g., an Attachment Unit Interface (AUI), an N connector, a vampire tap, a Bayonet Neill-Councilmen (BNC) connector, Small Form Factor Pluggable (SFP+), Registered Jack (RJ), etc. The I/O subsystem 610 can be communicatively coupled to any suitable device, e.g., a network, a computer, a switch, a decoder device, a network bridging device, a range extender, etc. The processing circuitry 618 can receive verifiable content 602 and public key/s 604, encapsulated within one or more Ethernet frames from the I/O subsystem 610.

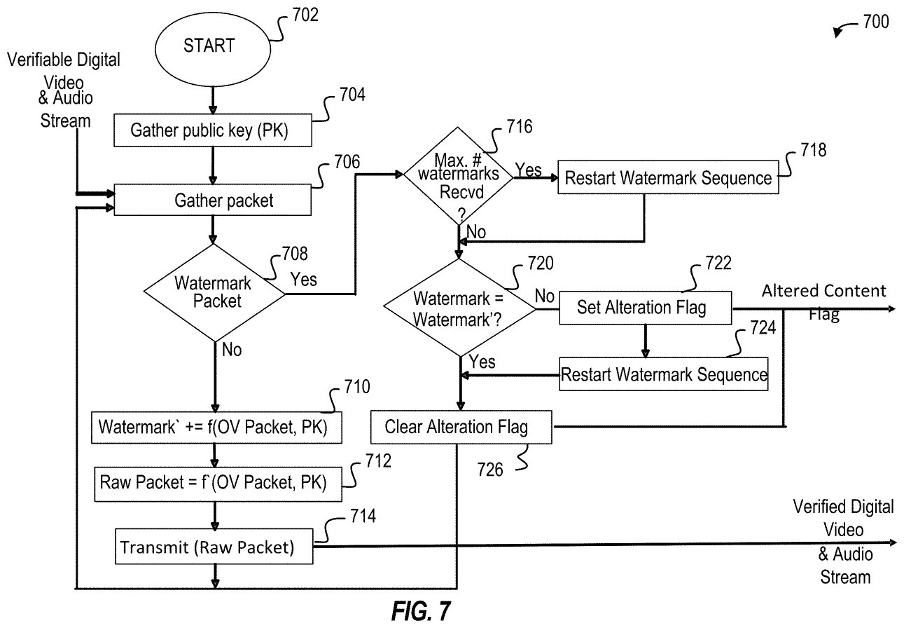

Once one or more Ethernet frames including video data have been received, the processing circuitry 618 can perform any of the operations of the method 700 illustrated in FIG. 7 to extract digital video and audio content 606 and possibly altered content flag/s 607 if digital video and audio content 606 is determined to have been spoofed or otherwise altered, based on watermark comparisons according to method 700.

After the video and audio content 606 has been reconstructed, the processing circuitry 618 can transmit the native video data using the I/O subsystem 610 to an output device (e.g., a monitor, a television, etc.). The exact configuration of the processing circuitry 618 is not limiting and can be similar to configurations previously discussed herein with respect to the processing circuitry 218 of FIG. 2.

### Method for Reconstructing Native Video Content

Referring to FIG. 7, the method 700 can begin at operation 702 with the processing circuitry 618 gathering public key/s and at least one packet of verifiable content of an Ethernet frame in operations 704 and 706. The public key/s will be incorporated within the Ethernet frame. In operation 708, the processing circuitry 618 determines whether the packet retrieved in operation 706 includes a watermark such as, for example, a watermark generated according to operation 316 (FIG. 3). Each Ethernet frame (comprised of a plurality of packets of verifiable content) may include only one watermark and accordingly not every packet gathered in operation 706 will include a watermark.

If the packet gathered in operation 706 does not include a watermark, as determined in operation 708, then, in operation 710, the processing circuitry 618 will increment a counter to a next packet for purpose of obtaining the watermark (Watermark′) in a next packet. The processing circuitry 618 will then extract raw video data in operation 712 using the public key and a previous watermark, by verifying the signature within metadata of the packet, wherein the metadata was added to the packet in operation 318 (FIG. 3). In operation 714, the processing circuitry 618 can transmit the raw packet to, for example, a display device or other reader system for displaying video content to a user of the user system/s 106 (FIG. 1).

If the packet gathered in operation 706 does include a watermark, as determined in operation 708, then, in operation 716, the processing circuitry 618 will determine whether a maximum number of watermarks has been received. In example embodiments, the maximum number of watermarks can be the same as the maximum number of watermarks set at the encoder apparatus 200 and checked in operation 326 (FIG. 3). If the maximum number of watermarks has been received, a watermark sequence will be re-started in operation 718, meaning that the first-generated watermark will be used for verifying the next subsequent Ethernet frame. Otherwise, the currently received watermark will be compared to an expected watermark in operation 720, where the expected watermark (Watermark′) was obtained in operation 710 when a previous packet was processed.

If the currently received watermark does not match the expected watermark, the processing circuitry 618 will set a flag in operation 722 indicating that the video content (e.g., Ethernet frame or portion thereof) has been altered. The flag set in operation 722 can also indicate that synchronization has been lost between the encoder apparatus 200 and the decoder apparatus 600 such that watermark sequencing at the decoder apparatus 600 may not match the watermark sequencing that was provided by the encoder apparatus 200. This indication can be used to provide an alarm to users of the user system/s 106 (FIG. 1), to content providers or other operators of the server/s 102 (FIG. 1), or for other warning and alarm systems. In some examples, the watermark sequence can be re-started at operation 724. For example, if synchronization was lost between the encoder apparatus 200 and the decoder apparatus 600, the encoder apparatus 200 and the decoder apparatus 600 can be resynchronized by re-starting the watermarking sequence. In any case, processing can continue with operation 726 by clearing alternation flags and gather subsequent packets.

### Other Components of the Encoder Apparatus and the Decoder Apparatus

Referring again to FIG. 2 and FIG. 6, further components of the encoder apparatus 200 and decoder apparatus 600 are described. In some embodiments, functionality and description will be similar for similar components. Where functionality is different, distinguishing description will be provided.

The memory 220, 620 can be embodied as any type of volatile (e.g., dynamic random-access memory (DRAM), etc.) or non-volatile memory or data storage capable of performing the functions described herein. Volatile memory can be a storage medium that requires power to maintain the state of data stored by the medium. Non-limiting examples of volatile memory can include various types of random-access memory (RAM), such as DRAM or static random-access memory (SRAM). One particular type of DRAM that can be used in a memory module is synchronous dynamic random-access memory (SDRAM).

In an example, the memory device is a block addressable memory device, such as those based on NAND or NOR technologies. A memory device can also include a three-dimensional crosspoint memory device, or other byte addressable write-in-place nonvolatile memory devices. The memory device can refer to the die itself and/or to a packaged memory product. In some examples, all or a portion of the memory 220, 620 can be integrated into the processing circuitry 218, 618. The memory 220, 620 can store various software and data used during operation such as one or more applications, data operated on by the application(s), libraries, and drivers.

The one or more illustrative data storage devices 212, 612 can be embodied as any type of devices configured for short-term or long-term storage of data such as, for example, memory devices and circuits, memory cards, hard disk drives, solid-state drives, or other data storage devices. Individual data storage devices 212, 612 can include a system partition that stores data and firmware code for the data storage device 212, 612. Individual data storage devices 212, 612 can also include one or more operating system partitions that store data files and executables for operating systems depending on, for example, the type of encoder apparatus 200 or decoder apparatus 600.

The communication circuitry 214, 614 can be embodied as any communication circuit, device, or collection thereof, capable of enabling communications over a network between the compute circuitry 208, 608 and another compute device (e.g., other devices in the system 100 (FIG. 1)). The communication circuitry 214, 614 can be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 214, 614 includes a network interface controller (NIC) 222, 622, which can also be referred to as a host fabric interface (HFI). The NIC 222, 622 can be embodied as one or more add-in-boards, daughter cards, network interface cards, controller chips, chipsets, or other devices that can be used by the encoder apparatus 200 or decoder apparatus 600 to connect with another compute device (e.g., other devices in the system 100 (FIG. 1)). In some examples, the NIC 222, 622 can be embodied as part of a SoC that includes one or more processors or included on a multichip package that also contains one or more processors. In some examples, the NIC 222, 622 can include a local processor (not shown) and/or a local memory (not shown) that are both local to the NIC 222, 622. In such examples, the local processor of the NIC 222, 622 can be capable of performing one or more of the functions of the compute circuitry 208, 608 described herein. Additionally, or alternatively, in such examples, the local memory of the NIC 222, 622 can be integrated into one or more components of the client compute node at the board level, socket level, chip level, and/or other levels.

Additionally, in some examples, a respective encoder apparatus 200 or decoder apparatus 600 can include one or more peripheral devices 216, 616. Such peripheral devices 216, 616 can include any type of peripheral device found in a compute device or server such as audio input devices, a display, other input/output devices, interface devices, and/or other peripheral devices, depending on the type of the encoder apparatus 200 or decoder apparatus 600. In further examples, the encoder apparatus 200 or decoder apparatus 600 can be embodied by a respective edge compute node (whether a client, gateway, or aggregation node) in an edge computing system or like forms of appliances, computers, subsystems, circuitry, or other components.

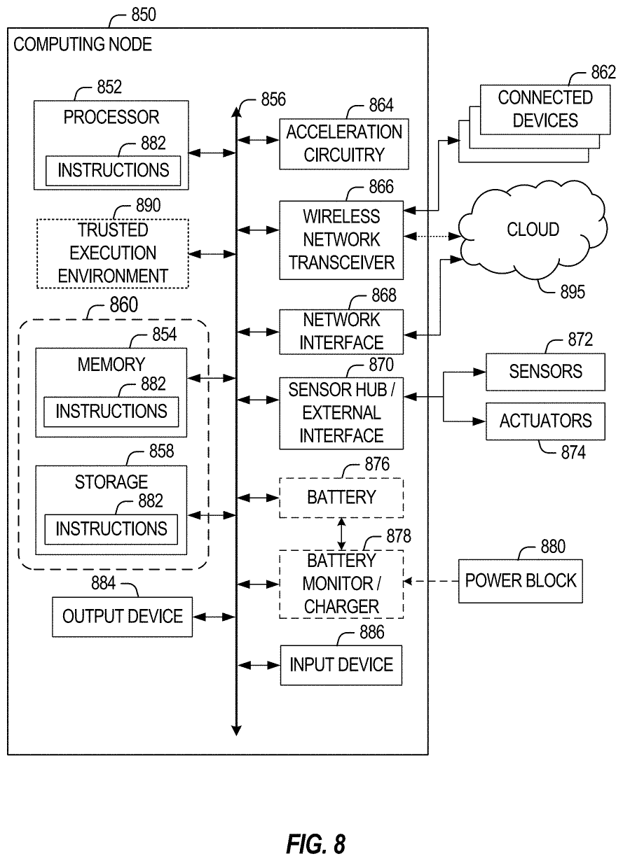

FIG. 8 illustrates a block diagram of an example of components that can be present in a computing device 850 for implementing the techniques (e.g., operations, processes, methods, and methodologies) described herein. This computing device 850 provides a closer view of the respective components of encoder apparatus 200 and decoder apparatus 600 when implemented as or as part of a computing device (e.g., as a mobile device, a base station, server, gateway, etc.). The computing device 850 can include any combinations of the hardware or logical components referenced herein, and it can include or couple with any device usable with a communication network or a combination of such networks. The components can be implemented as integrated circuits (ICs), portions thereof, discrete electronic devices, or other modules, instruction sets, programmable logic or algorithms, hardware, hardware accelerators, software, firmware, or a combination thereof adapted in the computing device 850, or as components otherwise incorporated within a chassis of a larger system.

The computing device 850 can include processing circuitry in the form of a processor 852, which can be a microprocessor, a multi-core processor, a multithreaded processor, an ultra-low voltage processor, an embedded processor, or other known processing elements. The processor 852 can be a part of a SoC in which the processor 852 and other components are formed into a single integrated circuit, or a single package. The processor 852 and accompanying circuitry can be provided in a single socket form factor, multiple socket form factor, or a variety of other formats, including in limited hardware configurations or configurations that include fewer than all elements shown in FIG. 8.

The processor 852 can communicate with a system memory 854 over an interconnect 856 (e.g., a bus). Any number of memory devices can be used to provide for a given amount of system memory. As examples, the memory 854 can be random access memory (RAM) in accordance with a Joint Electron Devices Engineering Council (JEDEC) design such as the DDR or mobile DDR standards (e.g., LPDDR, LPDDR2, LPDDR3, or LPDDR4). In examples, a memory component can comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) can be referred to as DDR-based standards and communication interfaces of the storage devices that implement such standards can be referred to as DDR-based interfaces. In various implementations, the individual memory devices can be of any number of different package types such as single die package (SDP), dual die package (DDP) or quad die package (Q17P). These devices, in some examples, can be directly soldered onto a motherboard to provide a lower profile solution, while in other examples the devices are configured as one or more memory modules that in turn couple to the motherboard by a given connector. Any number of other memory implementations can be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 858 can also couple to the processor 852 via the interconnect 856. In an example, the storage 858 can be implemented via a solid-state disk drive (SSDD). Other devices that can be used for the storage 858 include flash memory cards, such as Secure Digital (SD) cards, microSD cards, eXtreme Digital (XD) picture cards, and the like, and Universal Serial Bus (USB) flash drives. In an example, the memory device can be or can include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 858 can be on-die memory or registers associated with the processor 852. However, in some examples, the storage 858 can be implemented using a micro hard disk drive (HDD). Further, any number of new technologies can be used for the storage 858 in addition to, or instead of, the technologies described, such resistance change memories, phase change memories, holographic memories, or chemical memories, among others.

The components can communicate over the interconnect 856. The interconnect 856 can include any number of technologies, including industry standard architecture (ISA), extended ISA (EISA), peripheral component interconnect (PCI), peripheral component interconnect extended (PCIx), PCI express (PCIe), or any number of other technologies. The interconnect 856 can be a proprietary bus, for example, used in an SoC based system. Other bus systems can be included, such as an Inter-Integrated Circuit (I2C) interface, a Serial Peripheral Interface (SPI) interface, point to point interfaces, and a power bus, among others.

The interconnect 856 can couple the processor 852 to a transceiver 866, for communications with other connected devices 862. The transceiver 866 can use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, can be used for the connections to the connected devices 862. For example, a wireless local area network (WLAN) unit can be used to implement Wi-Fi® communications in accordance with the Institute of Electrical and Electronics Engineers (IEEE) 802.11 standard. In addition, wireless wide area communications, e.g., according to a cellular or other wireless wide area protocol, can occur via a wireless wide area network (WWAN) unit.

The wireless network transceiver 866 (or multiple transceivers) can communicate using multiple standards or radios for communications at a different range. For example, the computing device 850 can communicate with close devices, e.g., within about 10 meters, using a local transceiver based on Bluetooth Low Energy (BLE), or another low power radio, to save power. More distant connected devices 862, e.g., within about 50 meters, can be reached over ZigBee® or other intermediate power radios. Both communications techniques can take place over a single radio at different power levels or can take place over separate transceivers, for example, a local transceiver using BLE and a separate mesh transceiver using ZigBee®.

A wireless network transceiver 866 (e.g., a radio transceiver) can be included to communicate with devices or services in the cloud 895 via local or wide area network protocols. The wireless network transceiver 866 can be a low-power wide-area (LPWA) transceiver that follows the IEEE 802.15.4, or IEEE 802.15.4g standards, among others. The computing device 850 can communicate over a wide area using LoRaWAN™ (Long Range Wide Area Network) developed by Semtech and the LoRa Alliance. The techniques described herein are not limited to these technologies but can be used with any number of other cloud transceivers that implement long range, low bandwidth communications, such as Sigfox, and other technologies. Further, other communications techniques, such as time-slotted channel hopping, described in the IEEE 802.15.4e specification can be used.

Any number of other radio communications and protocols can be used in addition to the systems mentioned for the wireless network transceiver 866, as described herein. For example, the transceiver 866 can include a cellular transceiver that uses spread spectrum (SPA/SAS) communications for implementing high-speed communications. Further, any number of other protocols can be used, such as Wi-Fi® networks for medium speed communications and provision of network communications. The transceiver 866 can include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 868 can be included to provide a wired communication to nodes of the cloud 895 or to other devices, such as the connected devices 862 (e.g., operating in a mesh). The wired communication can provide an Ethernet connection or can be based on other types of networks, such as Controller Area Network (CAN), Local Interconnect Network (LIN), DeviceNet, ControlNet, Data Highway+, PROFIBUS, or PROFINET, among many others. An additional NIC 868 can be included to enable connecting to a second network, for example, a first NIC 868 providing communications to the cloud over Ethernet, and a second NIC 868 providing communications to other devices over another type of network.

Given the variety of types of applicable communications from the device to another component or network, applicable communications circuitry used by the device can include or be embodied by any one or more of components 864, 866, 868, or 870. Accordingly, in various examples, applicable means for communicating (e.g., receiving, transmitting, etc.) can be embodied by such communications circuitry.

The computing device 850 can include or be coupled to acceleration circuitry 864, which can be embodied by one or more artificial intelligence (AI) accelerators, a neural compute stick, neuromorphic hardware, an FPGA, an arrangement of GPUs, an arrangement of data processing units (DPUs) or Infrastructure Processing Units (IPUs), one or more SoCs, one or more CPUs, one or more digital signal processors, dedicated ASICs, or other forms of specialized processors or circuitry designed to accomplish one or more specialized tasks. These tasks can include AI processing (including machine learning, training, inferencing, and classification operations), visual data processing, network data processing, object detection, rule analysis, or the like.

The interconnect 856 can couple the processor 852 to a sensor hub or external interface 870 that is used to connect additional devices or subsystems. The devices can include sensors 872, such as accelerometers, level sensors, flow sensors, optical light sensors, camera sensors, temperature sensors, global navigation system (e.g., GPS) sensors, pressure sensors, barometric pressure sensors, and the like. The hub or interface 870 further can be used to connect the computing device 850 to actuators 874, such as power switches, valve actuators, an audible sound generator, a visual warning device, and the like.

In some optional examples, various input/output (I/O) devices can be present within or connected to, the computing device 850. For example, a display or other output device 884 can be included to show information, such as sensor readings or actuator position. An input device 886, such as a touch screen or keypad can be included to accept input. An output device 884 can include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing device 850. A display or console hardware, in the context of the present system, can be used to provide output and receive input of an edge computing system; to manage components or services of an edge computing system; identify a state of a computing component or service; or to conduct any other number of management or administration functions or service use cases.

A battery 876 can power the computing device 850, although, in examples in which the computing device 850 is mounted in a fixed location, it can have a power supply coupled to an electrical grid, or the battery can be used as a backup or for temporary capabilities. The battery 876 can be a lithium ion battery, or a metal-air battery, such as a zinc-air battery, an aluminum-air battery, a lithium-air battery, and the like.

A battery monitor/charger 878 can be included in the computing device 850 to track the state of charge (SoCh) of the battery 876, if included. The battery monitor/charger 878 can be used to monitor other parameters of the battery 876 to provide failure predictions, such as the state of health (SoH) and the state of function (SoF) of the battery 876. The battery monitor/charger 878 can include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 878 can communicate the information on the battery 876 to the processor 852 over the interconnect 856. The battery monitor/charger 878 can also include an analog-to-digital (ADC) converter that enables the processor 852 to directly monitor the voltage of the battery 876 or the current flow from the battery 876. The battery parameters can be used to determine actions that the computing device 850 can perform, such as transmission frequency, mesh network operation, sensing frequency, and the like.

A power block 880, or other power supply coupled to a grid, can be coupled with the battery monitor/charger 878 to charge the battery 876. In some examples, the power block 880 can be replaced with a wireless power receiver to obtain the power wirelessly, for example, through a loop antenna in the computing device 850. A wireless battery charging circuit can be included in the battery monitor/charger 878. The specific charging circuits can be selected based on the size of the battery 876, and thus, the current required. The charging can be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 858 can include instructions 882 in the form of software, firmware, or hardware commands to implement the techniques described herein. Although such instructions 882 are shown as code blocks included in the memory 854 and the storage 858, it can be understood that any of the code blocks can be replaced with hardwired circuits, for example, built into an application specific integrated circuit (ASIC).

In an example, the instructions 882 provided via the memory 854, the storage 858, or the processor 852 can be embodied as a non-transitory, machine-readable medium 860 including code to direct the processor 852 to perform electronic operations in the computing device 850. The processor 852 can access the non-transitory, machine-readable medium 860 over the interconnect 856. For instance, the non-transitory, machine-readable medium 860 can be embodied by devices described for the storage 858 or can include specific storage units such as optical disks, flash drives, or any number of other hardware devices. The non-transitory, machine-readable medium 860 can include instructions to direct the processor 852 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that can store, encode or carry instructions for execution by a machine and that cause the machine to perform any one or more of the methodologies of the present disclosure or that is capable of storing, encoding or carrying data structures utilized by or associated with such instructions. A “machine-readable medium” thus can include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium can further be transmitted or received over a communications network using a transmission medium via a network interface device utilizing any one of a number of transfer protocols (e.g., Hypertext Transfer Protocol (HTTP)).

A machine-readable medium can be provided by a storage device or other apparatus which is capable of hosting data in a non-transitory format. In an example, information stored or otherwise provided on a machine-readable medium can be representative of instructions, such as instructions themselves or a format from which the instructions can be derived. This format from which the instructions can be derived can include source code, encoded instructions (e.g., in compressed or encrypted form), packaged instructions (e.g., split into multiple packages), or the like. The information representative of the instructions in the machine-readable medium can be processed by processing circuitry into the instructions to implement any of the operations discussed herein. For example, deriving the instructions from the information (e.g., processing by the processing circuitry) can include compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions can include assembly, compilation, or interpretation of the information (e.g., by the processing circuitry) to create the instructions from some intermediate or preprocessed format provided by the machine-readable medium. The information, when provided in multiple parts, can be combined, unpacked, and modified to create the instructions. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable, etc.) at a local machine, and executed by the local machine.

All references and publications cited herein are expressly incorporated herein by reference in their entirety into this disclosure, except to the extent they can directly contradict this disclosure. Illustrative embodiments of this disclosure are described, and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. An encoder apparatus comprising:
an input/output (I/O) subsystem to receive video data comprising a plurality of packets;
processing circuitry coupled to the I/O subsystem and configured to:
gather a packet from the plurality of packets of the video data;
generate a first watermark for signing the packet;
generate the signed packet based on the first watermark; and
encode an Ethernet frame comprising at least the signed packet.

2. The encoder apparatus of claim 1, wherein the processing circuitry is further configured to transmit a public key for decoding the signed packet.

3. The encoder apparatus of claim 2, wherein the processing circuitry is configured to generate the first watermark based on the public key.

4. The encoder apparatus of claim 1, wherein the processing circuitry is further configured to:
gather a subsequent packet from the video data; and
calculate a second watermark, based on the first watermark, for signing the subsequent packet.

5. The encoder apparatus of claim 4, wherein the second watermark comprises a second watermark portion concatenated to the first watermark.

6. The encoder apparatus of claim 4, wherein the processing circuitry is further configured to:
gather a number of subsequent packets subsequent to the subsequent packet; and
calculate a number of additional watermarks, sequentially, with each of the additional watermarks being a concatenation comprising a new portion and the previous watermarks.

7. The encoder apparatus of claim 1, wherein the packet comprises at least a portion of a video line.

8. The encoder apparatus of claim 1, wherein the packet comprises a horizontal video line.

9. The encoder apparatus of claim 1, wherein the Ethernet frame comprises a segment number that indicates a position of the packet in the plurality of packets.

10. The encoder apparatus of claim 1, wherein the Ethernet frame comprises a cyclic redundancy check (CRC) field indicating that the CRC field should be ignored.

11. The encoder apparatus of claim 10, wherein the CRC field is comprised of zeroes.

12. A decoder apparatus comprising:
a decoder input to receive a plurality of Ethernet frames; and
processing circuitry operably coupled to the decoder input and configured to:
receive the plurality of Ethernet frames, each Ethernet frame of the plurality of Ethernet frames comprising a watermark and a plurality of packets of video content;
reconstruct the video content based on the watermark and on the plurality of packets; and
provide the reconstructed video content to a display device.

13. The decoder apparatus of claim 12, wherein the processing circuitry is further configured to:
receive a public key corresponding to at least one Ethernet frame of the plurality of Ethernet frames; and
reconstruct the video content based also on a public key.

14. The decoder apparatus of claim 12, wherein providing the video content to a display device comprises:
determining whether the watermark matches an expected watermark; and
providing video content corresponding to the watermark if the watermark matches an expected watermark, and set an alteration flag otherwise.

15. The decoder apparatus of claim 12, wherein the processing circuitry is configured to:
gather individual packets from an Ethernet frame of the plurality of Ethernet frames;
detect whether the individual packets includes a watermark; and
if a packet of the individual packets does not include the watermark, provide the packet to the display device, and compare the watermark to an expected watermark otherwise.

16. The decoder apparatus of claim 12, wherein the processing circuitry is configured to ignore a cyclic redundancy check (CRC) field within at least one Ethernet frame of the plurality of Ethernet frames.

17. A system comprising:
a network interface configured to receive a plurality of packets comprising digital video and audio content;
an encoder apparatus coupled to the network interface and configured to:
gather a packet from the plurality of packets;
generate a first watermark for signing the packet;
generate a signed packet based on the watermark; and
provide an Ethernet frame for transmission, the Ethernet frame comprising at least the signed packet;
a decoder apparatus, coupled to the encoder apparatus and configured to reconstruct the packet based on the watermark.

18. The system of claim 17, wherein the encoder apparatus is further configured to provide a public key for decoding the signed packet.

19. The system of claim 18, wherein the encoder apparatus is further configured to generate the first watermark based at least in part on the public key.
